(19) United States
(12) Patent Application Publication
(10) Pub. No.: US 2002/0040317 A1
(43) Pub. Date: Apr. 4, 2002

(54) Conducting asynchronous interviews over a network

(76) Inventors: Leonardo Neumeyer, Palo Alto, CA (US); Dimitry Rtischev, Los Altos, CA (US); Diego Doval, Mountain View, CA (US); Juan Gargiulo, Palo Alto, CA (US); Dylan Parker, Palo Alto, CA (US)

Correspondence Address: Hickman Palermo Truong & Becker, LLP, 1600 Willow Street, San Jose, CA, 95125-5106, US

(21) Appl. No.: 09/912,644

(22) Filed: Jul. 24, 2001

Related U.S. Application Data
(60) Provisional application No. 60/224,550, filed on Aug. 10, 2000.

(51) Int. Cl. G06F 17/60

(52) U.S. Cl. 705/11; 709/203

(57) ABSTRACT

A method and apparatus are described for asynchronously conducting interviews though a user interface executing on a client. The user interface prompts an interviewee for at least one audio response, which is digitally recorded. User interfaces are generated by a client according to code defining the user interfaces downloaded from a server via, for example, the Internet. The server may be remote from the client, thereby allowing interviewees to interact with the user interfaces on their own computers. The user interface queries an interviewee and the interviewee responds, either by entering text or digitally recording a response using controls supplied by the user interface. The responses are down loaded via, for example, the Internet to a server. Evaluators may review an interviewee's response through the use of user interfaces. A user (e.g. interviewer) may specify the format of asynchronous interviews, by providing user input that specifies queries to ask, the manner of asking the queries, and the manner in which an interviewee may respond. Based on the user input, data defining the format of an asynchronous interview is generated and may be stored, for example, on a server.

### FIELD OF THE INVENTION

The present invention relates to automation of interview processes between individuals and organizations.

### BACKGROUND OF THE INVENTION

The process of screening applicants for employment or a position in an organization is often initiated by submittal of written applications by applicants interested in the position. In general, the applications provide sufficient information to evaluators for the evaluators to ascertain which candidate possesses the requisite experience and education. However, written applications are not effective for measuring some traits desired for a position, such as personality and ability to orally communicate. Furthermore, written applications are vulnerable to misrepresentation. Consequently, qualified applicants are generally interviewed in-person, to not only gather additional information or to gage a persons speaking ability and personality, but to elicit spontaneous responses to questions about their qualifications, responses that allow interviewers to gage an applicant's knowledge, thinking ability, and command of the subject matter relevant to the position.

While in-person interviews are an indispensable tool to evaluating applicants, the interview process has many drawbacks. Scheduling an interview is often beset with difficulty. Finding a time suitable to all the interviewers and an applicant may be difficult, and often involves compromises. For example, interviews are scheduled at undesirable times with less than all the desired interviewers. Often, the set of interviewers who interview a group of applicants applying for the same position may differ between applicants in the group.

The interviewing process is also expensive. Applicants are usually compensated for travel expenses. The interview requires time of the interviewers, time that could otherwise be used for other duties. Typically, an applicant interviews with a group of interviewers, meeting individually with each interviewer or different subsets of the interviewers. When the applicant arrives at the interview location, the interviewers attempt to have all scheduled interviewers interview the candidate, so that each may personally evaluate the candidate. Often, all scheduled interviews are conducted even for candidates that are obviously unqualified, and whose lack of qualification could have been determined by less than all the scheduled interviewers. As a result, interviewer time is wasted interviewing patently unqualified candidates.

Often, interviewers have interview skills and formats that vary widely. As a result, the decision of which candidates are the most suitable may be influenced by ineffective interviewers or interviewers following different interview formats. When, as mentioned before, the set of interviewers that interview applicants for the same position differs between applicants, candidates are evaluated inconsistently, and comparison between them is more difficult.

At the conclusion of an interview of an applicant, interviewers usually are only able to document very little information about the interview. Often, the information recorded is a brief summary of their impressions of the applicant. Sometimes no information is recorded at all. As a result, those evaluating an applicant must rely on very little documentation about an interview, their own memory of the applicant, or the memory of another interviewer.

Most interviewed applicants realize that what they assert in an interview is subject to little if any documentation, and that they will unlikely have to account for the inaccuracy of any assertions about their qualifications made in an interview. Because of this lack of accountability, many interviewees misrepresent or exaggerate their qualifications to interviewers. In fact, an assertion made with one interviewer may contradict an assertion made with another.

Based on the foregoing, it is clearly desirable to provide a mechanism for screening and interviewing applicants that is more convenient and economical to both the interviewers and applicants than the conventional screening processes, that is informative as to verbal, thinking skills, and personality traits, and that documents an interview and provides convenient access to the documentation.

### SUMMARY OF THE INVENTION

Techniques are provided for asynchronously conducting interviews though a user interface executing on a client. The user interface prompts an interviewee for at least one audio response, which is digitally recorded. According to an aspect of the present invention, user interfaces are generated by a client according to code defining the user interfaces downloaded from a server via, for example, the Internet. The server may be remote from the client, thereby allowing interviewees to interact with the user interfaces on their own computers. The user interface queries an interviewee and the interviewee responds, either by entering text or digitally recording a response using controls supplied by the user interface. The responses are down loaded via, for example, the Internet to a server. Evaluators may review an interviewee's response through the use of user interfaces.

According to another aspect of the present invention, a user (e.g. interviewer) may specify the format of asynchronous interviews. A user may provide user input that specifies queries to ask, the manner of asking the queries, and the manner in which an interviewee may respond. Based on the user input, data defining the format of an asynchronous interview is generated and may be stored, for example, on a server.

### BRIEF DESCRIPTION OF THE DRAWINGS

The present invention is illustrated by way of example, and not by way of limitation, in the FIGS. of the accompanying drawings and in which like reference numerals refer to similar elements and in which:

FIG. 1 is a block diagram depicting an exemplary architecture of an embodiment of the present invention;

FIG. 2 is a block diagram depicting a server which participates to configure and generate asynchronous interviews according to an embodiment of the present invention;

FIG. 3A is diagram that depicts a user interface used to conduct asynchronous interviews according to an embodiment of the present invention;

FIG. 3B is diagram that depicts a user interface used to conduct asynchronous interviews according to an embodiment of the present invention;

FIG. 3C is diagram that depicts a user interface used to conduct asynchronous interviews according to an embodiment of the present invention;

FIG. 4 is a block diagram depicting the logical elements of a data structures used to define formats for asynchronous interviews according to an embodiment of the present invention;

FIG. 5 is a block diagram depicting a display representing the contents of a speech room according to an embodiment of the present invention; and

FIG. 6 is a block diagram depicting a computer system that may be used to implement an embodiment of the present invention.

### DETAILED DESCRIPTION OF THE PREFERRED EMBODIMENT

A method and apparatus for conducting asynchronous interviews is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Overview

Described herein are techniques and mechanisms for conducting “asynchronous interviews”. An asynchronous interview is a series of queries directed to an interviewee, and responses provided by an interviewee, that involve verbal communication that does not occur concurrently between interviewees and interviewers, as verbal communication occurs in face-to-face interviews or telephone interviews. The term “query” refers to either a question to ask an interviewee or a request for information from the interviewee.

According to an embodiment, the asynchronous interviews are accomplished through user interfaces running on a client. The user interfaces are generated by a client according to code defining the user interfaces downloaded from a server via, for example, the Internet. The server may be remote from the client, thereby allowing interviewees to interact with the user interfaces on their own computers. The user interface queries an interviewee and the interviewee responds, either by entering text or digitally recording a response using controls supplied by the user interface. The responses are down loaded via, for example, the Internet to a server. Evaluators may review an interviewee's response through the use of user interfaces.

In addition, a user (e.g. interviewers) may specify the format of asynchronous interviews. A user may provide user input that specifies queries to ask, the manner of asking (e.g. textually or by use of digitally recorded speech), and the manner in which an interviewee may respond. Data defining the format of an asynchronous interview is generated and stored on a server. The server then generates code defining user interfaces through which asynchronous interviews are conducted, according to the data defining the format of the asynchronous interview.

Because an interviewee may participate in the interviewing process through interaction with user interfaces running on the interviewee's computer, an interviewee does not have to travel to an interview location. Consequently, travel expenses are reduced. No in-person meetings have to be scheduled between interviewees and interviewers. This flexibility reduces scheduling difficulties. The ability to review verbal responses enables spoken skills to be evaluated, and to a degree, personality traits. The responses are persistently recorded, thereby enhancing accountability and reducing misrepresentation by interviewees.

### Exemplary Architecture

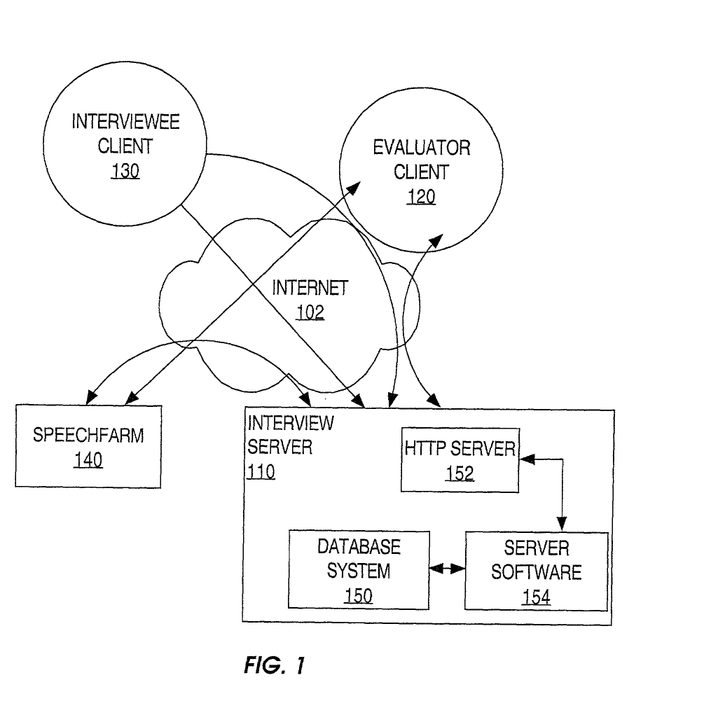

FIG. 1 is a block diagram of a system architecture that includes depicts various components that participate in the production of asynchronous interviews. Interview server 110 is a server that contains various software and hardware components used to administer asynchronous interview processes and provide interviewing services to clients. Interviewing services include services for conducting asynchronous interviews, for obtaining and managing information about asynchronous interviews, for defining and controlling asynchronous interview content (e.g. questions asked and how they may be responded to), and providing user interfaces through which such services may be accessed. Typically, such services involve transmission of information between interview server 110 via the Internet 102 with clients, such as Evaluator client 120 and Interviewee client 130. Alternately, information may be communicated via any local area network or wide area network, public or private.

Evaluator client 130 is a computer system operating under the control of an interviewee, and evaluator client 120 is a computer system operating under the control of an organization desiring to conduct asynchronous interviews with interviewees, such as job applicants for a position within a company. Information communicated between interview server 110 to clients 120 and 130 may include transmission of files, plug-in programs, applets, such as those written in Java or ActiveX, and graphical and audio data, as shall be described in greater detail. Information transmitted from clients 120 and 130 to interview server 110 may include data files, digital audio data, graphical data, and form-based submissions, as shall be described in greater detail. While the techniques for asynchronous interviewing are illustrated using one client for the interviewee and one client for the evaluators of the interviewees, any number of clients for the interviewee or evaluator may be used.

Interview Server 110 includes hyper text protocol (HTTP) server 152. An HTTP server is a server capable of communicating with a browser running on client using the hypertext text protocol to deliver files (“pages”) that contain code and data that conforms to the hypertext markup language (HTML). The HTML pages associated with a server provide information and hypertext links to other documents on that server and (often) other servers. A browser is a software component on a client that requests, decodes, and displays information from HTTP servers, including HTML pages.

The pages provided to the browser of a client may be in the form of static HTML pages. Static HTML pages are created and stored at the HTTP server prior to a request from a browser for the page. In response to a request from a browser, a static HTML page is merely read from storage and transmitted to the requesting browser.

In addition, an HTTP server may respond to browser requests by dynamically generating pages or performing other requested dynamic operations. To perform dynamic operations, the functionality of the HTTP server 152 must be enhanced or augmented by server software 154. Server software 154 and HTTP server may interact with each other using the common gateway interface (CGI) interface protocol.

Many pages transmitted by interview server 110 to clients 120 and 130 contain code that defines graphical user interfaces (GUI). When a browser decodes the pages, it generates a GUI. A GUI or any user interface generated by a client through execution of code provided, at least in part, by pages transmitted by interview server 110, is herein referred to as a supplied GUI. A user may interact with a supplied GUI to enter, for example, textual data or audio data. The text is submitted to HTTP server 152 as form data. HTTP server 152 in turn invokes server software 154, passing the form data as input.

Pages transmitted by HTTP server software may also contain embedded code, scripts, or programs that are executed at the client. These programs can be, for example, Java applets, Java scripts, or ActiveX controls. The programs may be stored temporarily in the cache of a client, or more permanently as, for example, one or more plug-in applications.

Database system 150 holds information used to administer asynchronous interviews. Database system 150 may be a relational database system, object relational database system, or any conventional database system.

Interviewee client 120 and evaluator client 130 are configured to play digital audio data to a user and to receive digital audio data generated from audio input of a user. Clients 120 and 130 operate on a client configured with audio hardware, which may include a sound card, speakers, and a microphone, and an operating system with system drivers for interfacing with audio hardware. In addition, clients 120 and 130 include audio application software that enables a user to play back and record software, and that enables the client to record, receive, and transmit digital audio data. The audio applications may be in the form of applets downloaded from interview server 110, or preferably, SpeechFarm 140.

SpeechFarm 140 is a server that provides speech services to servers and clients of servers, such as interview server 110 and its clients, evaluator client 120 and interviewee client 130. A speech service may be (1) the processing of digital speech data recorded at a client, or (2) the delivery of software which, when executed, operates on digital speech data. The digital speech services provided by SpeechFarm 140 may be used to analyze, transmit, and store digital speech data.

For example, a page defining a supplied GUI contains a module in the form of embedded code that refers to an audio application on SpeechFarm 140. A browser on a client decoding the page downloads the application. The browser executes the audio application, providing the user access to the application through the GUI. The user then interacts with the GUI to either hear or record digital audio data. If recording digital audio data, it may be transmitted to SpeechFarm 140 and later retrieved by Interview Server 110. Alternatively, the data may be transmitted directly from the client executing the audio application to interview server 110. Likewise, if listening to a digital audio recording, the audio application executing on the client may retrieve digital audio data from SpeechFarm 140 on behalf of interview server 110, or directly from interview server 110. A SpeechFarm is described in U.S. application Ser. No. 09/535,061, entitled “Centralized Processing Of Digital Speech Data Originated At The Network Clients Of A Set Of Servers”, filed by Leonardo Neumeyer, Dimitry Rtischev, Diego Doval, and Juan Gargiulo on Jan. 25, 2000.

The exemplary architecture depicted in FIG. 1 is based on a client-server model, where the server downloads user interfaces executed on a client. However, the present invention is not limited to an implementation based on such a client-server model. For example, a client may already have an “interview-taking” application installed in the form of machine executable code that, when executed, reads from a server data defining an asynchronous interview format. The interview-taking application conducts an asynchronous interview according to the downloaded data. Or, the application may not retrieve data defining a format from a server, but instead may retrieve such data from its own local data storage mechanisms (e.g. local files, database system, floppy, CD-ROM). Finally, the application may persistently record an interviewees responses by either transmitting data back to a server or storing the data persistently on the client in a local storage mechanism. The application may be an interview-making application configured to receive user input, and to generate the data defining asynchronous interviews based on the user input.

### Database Elements

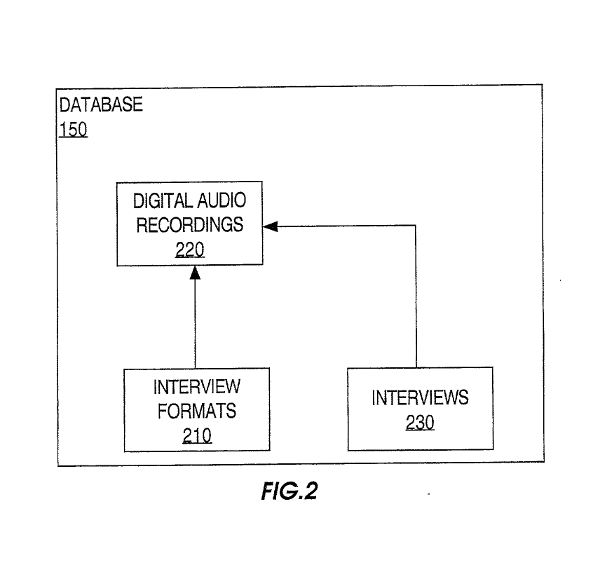

FIG. 2 shows logical elements of database system 150 in greater detail. Database 150 includes interview formats 210, interviews 230, and digital audio recordings 220. Interview formats 210 and interviews 230 may be organized as one or more tables in database system 150. Interview formats 210 contains interview formats; each interview format is logically a record that describes the composition of an asynchronous interview. The composition of an asynchronous interview refers to interviewee queries (e.g. questions to ask of interviewees, requests for information, the manner in which to execute the query (text or speech), and the manner the interviewee should respond to the query. Data elements that comprise an interview format shall be described in greater detail.

Interviews 230 contain information used to manage asynchronous interviews. For each asynchronous interview, interviews 230 holds information such as data that identifies the interviewees, and data that specifies the date and time the interview commenced, data that identifies the interview format, and data that identifies the digital audio recordings for interview responses to queries.

Digital audio recordings 220 is a collection of digital audio recordings of queries and responses to queries. Digital audio recordings 220 are stored as binary large objects in database system 150. Alternatively, digital audio recordings may be stored as one or more files in a system of file directories not under the control of database system 150.

### Interview GUIs

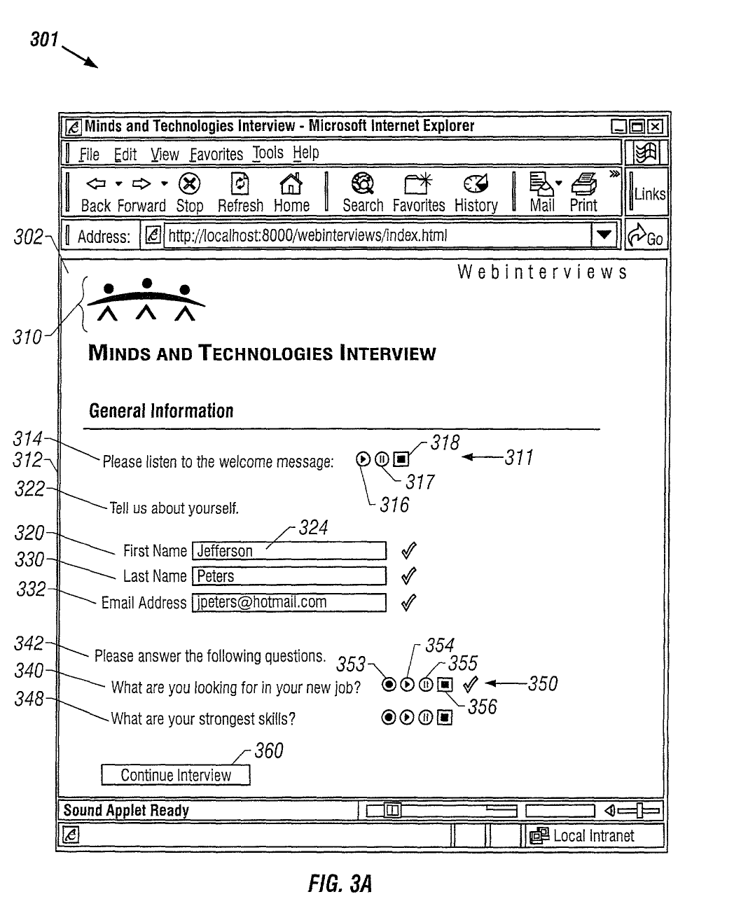

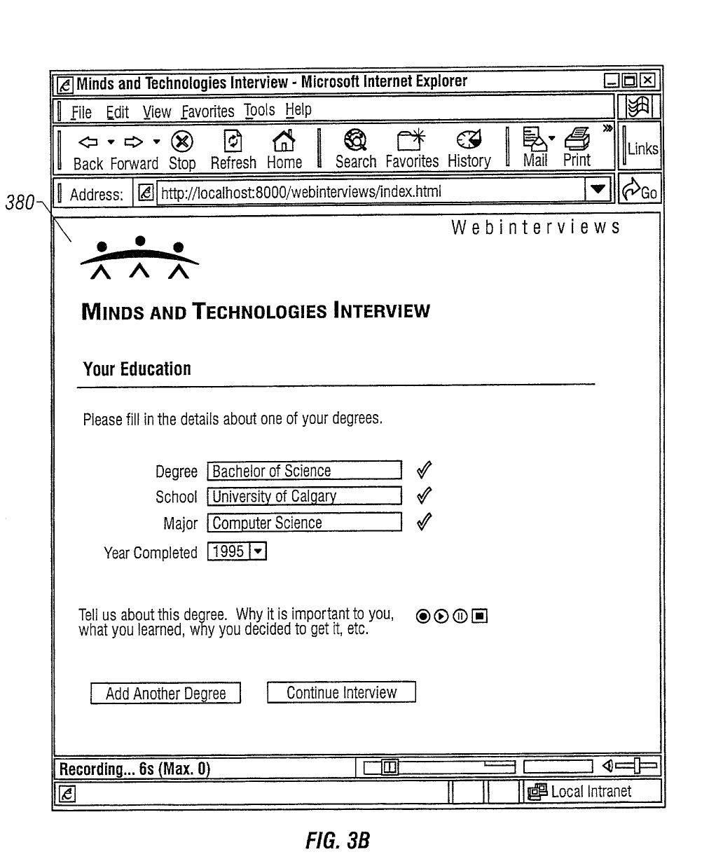

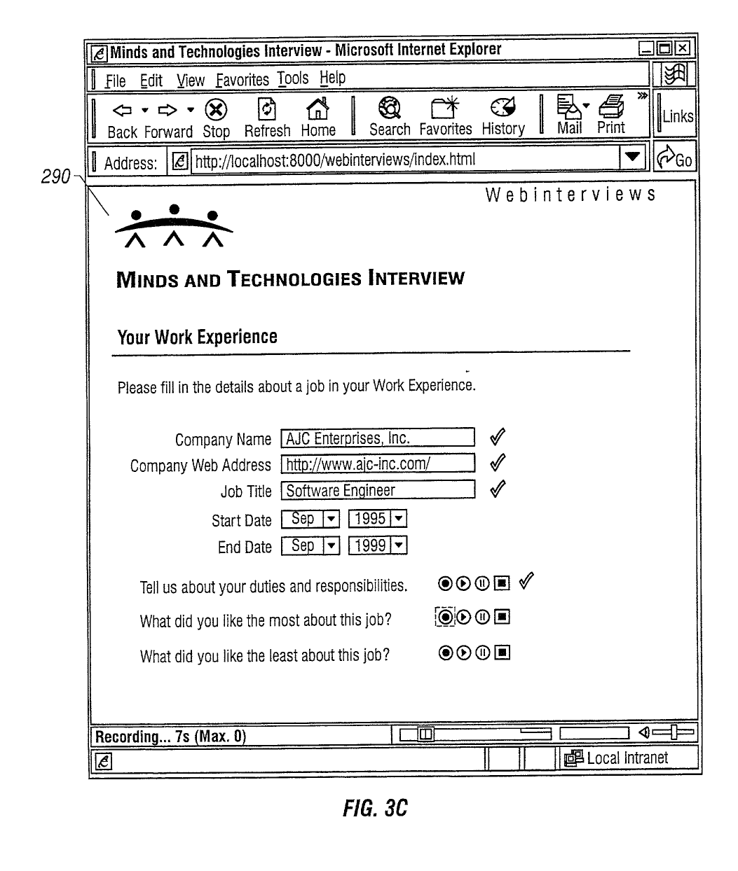

Asynchronous interviews are conducted through interview GUIs executed on a browser of evaluator client 130. FIGS. 3A, 3B, 3C depict an interview GUI displayed within display page 302 in browser display 301. A display page is the graphical presentation generated within the display area of browser in response to a browser executing one or more pages. A display page may display numerous graphical controls; a GUI may include one or more display pages. The interview GUI depicted in FIGS. 3A, 3B, and 3C is described to not only convey operational and graphical features of an interview GUI, but also how an interview GUI and an interviewee interact during the course of an asynchronous interview.

Referring to FIG. 3A, display page 302 presents graphical controls of an interview GUI. Graphic 310 is a graphic describing the organization of the evaluator. Welcome Message Controls 312 is a set of graphical controls used to present an audio welcome message to the interviewee. Welcome message controls, such welcome message controls 312, are displayed on the first display page of an interview GUI display. Welcome message controls 312 include welcome text 314, which is displayed as a label in association with audio control buttons 311.

Audio control buttons, such as audio control buttons 311, are graphical user controls that may be manipulated by an interviewee to control the playback of a digital audio recording, or to generate a digital audio recording. Audio control buttons 311 include playback button 316, stop button 317, and rewind button 318. Playback button 316 may be manipulated to play back the digital audio welcome message. Stop button 317 may manipulated to stop play of the digital audio welcome message. Once stopped, playback may be recommenced by manipulating playback button 316. Rewind button 318 causes the playback to commence at the beginning of the digital audio message the next time playback button 316 is manipulated to play the digital message.

Query controls, such as query controls 320, are a set of graphical user controls used to present a query to the interviewee and to input the interviewee's response. Query controls 320 include query text 322 and answer text box 324. Query controls 320 is an example of a query that is communicated textually and that is responded to by entering text. In the case of the query presented by query controls 320, the interviewee is being queried for the interviewee's first name. Query text 322 is the text of the query. The interviewee responds to the query by entering text into answer text box 324. Query controls 330 query the interviewee for their last name, and query controls 332 query the interviewee for their email address.

Query controls 340 and 348 are examples of a query that is communicated textually, but that is responded to verbally by recording a digital audio message. Query controls 340 includes query text 342 and recording control buttons 350. Recording control buttons 350 include record button 353, playback button 354, stop button 55, and rewind button 356. Record button 353 may be manipulated by the interviewee to commence recording a digital audio response. Playback button 354, stop button 355 and rewind button 356 function similarly to audio control buttons 311 to playback, stop, rewind a digital audio response. Furthermore, stop button 355 may be manipulated to halt recording a digital audio response.

Continue command button 360 may be manipulated by an interviewee to display the next display page in an interview GUI in the display area of a browser. FIG. 3B and 3C depict other display pages in the interview GUI. FIG. 3B depicts display page 380, and FIG. 3C depicts display page 390.

### Interview Formats

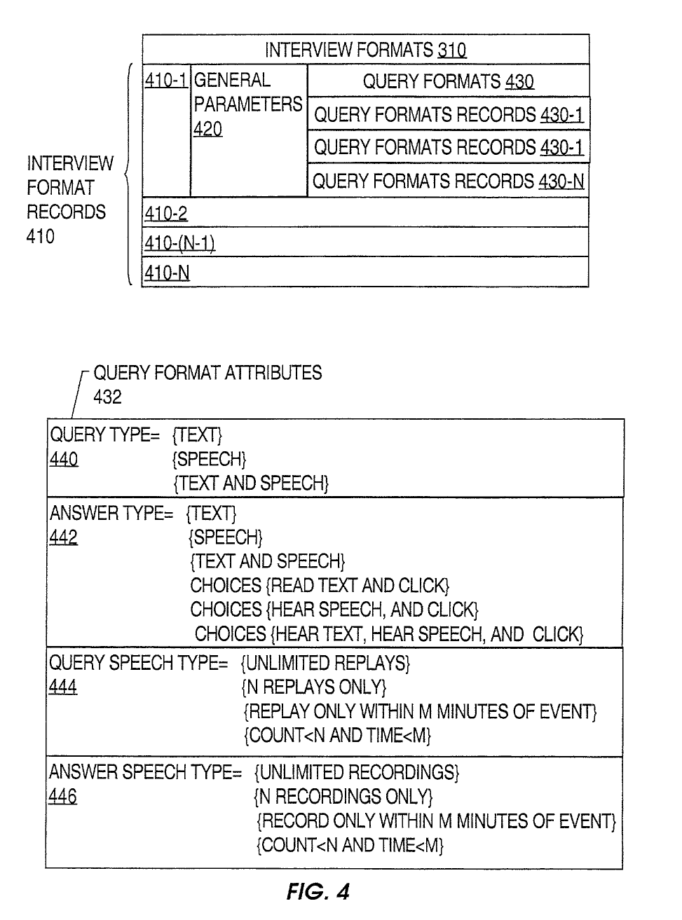

FIG. 4 is a block diagram that logically depicts data elements of interview formats 210. Referring to FIG. 4, interview formats 210 includes interview format records 410. Each format record describes the composition of an asynchronous interview, and is used to generate attributes of an interview GUI for querying and receiving responses from an interviewee.

Referring to FIG. 4, an interview format record 410-1 includes general interview parameters 420 and query format records 430. Interview format records 410 have the same or similar structures as those specified for interview format record 410-1. General parameters 420 are attributes that apply to general features of an interview GUI. For example, general parameters may specify attribute values for the background color and pattern of the display pages of an interview GUI, an interview title to display in the display pages, text or audio recordings for introductory and concluding remarks to be presented to an interviewee, default font attributes, and graphics to display at the top and bottom of an interview GUI display page.

Query format records 430 contain query format records 430-1-430-N. Each query format record specifies attributes of a query, including query format attributes 432, and other attributes not depicted, such as font attributes for the query format. Query Format Attributes 432 include query type 440, answer type 442, query speech types 444 and answer speech type 446.

Query Type 440 may contain one of three values that each specify one of three modes for communicating a query to an interviewee. The values and their corresponding modes are shown in Table A below.

TABLE A

| LOGICAL VALUE | MODE OF COMMUNICATION |
|---|---|
| {TEXT} | Display Text |
| {SPEECH} | Generate Speech Stating the query |
| {TEXT AND SPEECH} | Display Text and Generate Speech |

Answer Type 442 may contain one of six values that each specify a mode for an interviewee to communicate a response to a query. The values and their corresponding modes are described below in Table B.

TABLE B

| LOGICAL VALUE | MODE OF COMMUNICATION |
|---|---|
| {text} | Interviewee responds by entering text |
| {speech} | Interviewee responds by recording a |
| | digital audio response |
| {text and speech} | Interviewee responds by both entering |
| | text and recording a digital audio response |
| {choices-read text and click} | Interviewee selects an answer from |
| | multiple choices displayed to user in text, |
| | by, for example, clicking on a button in a |
| | GUI that corresponds to one of the |
| | choices. |
| {choices-hear speech, and | Interviewee selects an answer from |
| click} | multiple choices communicated to him |
| | through a digital audio recording |
| {choices-read text and hear | Interviewee selects an answer from |
| speech, and click} | multiple choices communicated to him |
| | using both text and a digital audio |
| | recording |

Query speech type 444 contains one of four values that each specify a mode for replaying queries communicated to the interviewee using speech. This attribute need contain a value only when query type 440 specifies a mode of communication that uses speech. The values and their corresponding modes are described below in Table C.

TABLE C

| LOGICAL VALUE | MODE OF COMMUNICATION |
|---|---|
| {unlimited replays} | Interviewee may replay a speech query |
| | as many times as desired. |
| {N replays only} | Interviewee may replay a speech query |
| | no more than N times. |
| {replay only within M | Interviewee may replay speech query |
| minutes of event} | any time with M minutes of originally |
| | playing speech query. |
| {count <N and time <M} | Interviewee may replay speech query |
| | any time with M minutes but no more |
| | than N times. |

Answer speech type 446 contains one of four values that each specify a mode for limiting how an interviewee may respond to a query in digital recorded speech. This attribute need contain a value only when answer type 442 specifies a mode of communication that uses speech. The values and their corresponding modes are described below in Table D.

TABLE D

| LOGICAL VALUE | MODE OF COMMUNICATION |
|---|---|
| {unlimited recordings} | Interviewee may recprd a response |
| | as many times as desired. |
| {N recordings only} | Interviewee may record a response |
| | no more than N times. |
| {record only within M | Interviewee may record a response |
| minutes of event} | any time within M minutes of originally |
| | playing the speech query. |
| {count <N and time <M} | Interviewee may record a response |
| | any time with M minutes but no more |
| | than N times. |

A query format record may include other attributes not shown. Furthermore, whether these other attributes contain a value depends on the values in query format attributes 432. For example, if query type 440 equals {text}, query format record 430-1 will contain the text of the question. If query type 440 equals {choices-read text and click }, then query format record 430-1 will contain the text of each choice. If query type 440 equals {speech }, then query format record 430-1 will contain either an identifier or reference to the digital audio recording in digital audio recordings 220 for a speech query.

### Creating and Maintaining Interview Formats

Interview formats are created from information gathered from a user through one or more supplied GUIs. The information (i.e. form data, audio digital data) is transmitted to interviewer server 110, which executes server software 154 to further process the information and record it in database system 150. A supplied GUI provides controls and functions for creating, modifying, and maintaining interview formats. Such a GUI may include the functions as listed and further described in Table E.

TABLE E

| Function/Function Group | Description |
|---|---|
| Select Interview Format | Enables selection of an existing or new |
| | interview format to update. |
| New Query | Add a query to an interview format |
| Choose Query Type | Input/Edit value for query type 440 |
| Enter query content | Input/Edit text for query and/or record |
| | audio input for query. |
| Choose Answer Type | Input/Edit value for query type 440 |
| Enter choices content | Input/Edit text for choices and/or record |
| | digital audio data for query. |
| Edit Query | Edit an existing query in a interview format. |
| Edit Query Type | Input/Edit value for query type 440 |
| | audio data for query. |
| Edit Answer Type | Input/Edit value for query type 440 |
| Edit choices content | Input/Edit text for choices and/or record |
| | digital audio date for query. |
| Edit General Parameters | |
| Specify background | Input values for background color, pattern, |
| | and other back ground characteristics. |
| Specify fonts | Input values for that specify the default font |
| Upload graphic for top of | Interface that allows a user to upload graphic |
| page | files to be displayed at top of display page of |
| | an interview GUI. Graphics files include, |
| | for example, bitmap files or files formatted |
| | according to the graphics interchange format |
| | (GIF). |
| Upload graphic for top of | Interface that allows user to upload graphic |
| page | files to be displayed at top of display page of |
| | an interview GUI. |
| Enter title text | Input of text for title to display in interview |
| | GUI. |
| Enter introductory | Input/Edit text for query an/or record digital |
| remarks content | audio data for introductory remarks |
| Enter concluding remarks | Input/Edit text for query an/or record digital |
| content | audio data for concluding remarks |

### Conducting Asynchronous Interviews

An asynchronous interview is initiated when HTTP Server 152 receives a request to begin an interview from a browser on interviewee client 130. The request identifies a particular interview format record in interview formats 310. HTTP server 152 invokes server software 154, passing in the identified interview format record. In response, the interview server 110 creates a record in interviews 230 for the requested interview, retrieves information about the identified interview format record, and generates pages defining an interview GUI according to data in the record. The generated pages are downloaded to interviewee client 130.

Interaction between the interviewee and the downloaded interview GUI generates form data and digital audio recordings representing responses to queries. The form data is transmitted to HTTP server 152, which invokes server software 154, causing interview server 110 to store the form data, or data derived therefrom, in the record in interviews 230. The digital audio recordings are downloaded to interview server 110, either directly from interviewee client 130 or indirectly via SpeechFarm 140. The downloaded digital audio recordings are stored in digital audio recordings 220. Interviews 230 is updated to associate the received digital audio recordings with the interview record and corresponding query in the interview format record.

Browser requests to begin an interview may be initiated in a variety of ways. A browser may be directed to interview server 110 from a site operated by an evaluator. For example, using a browser on a client, a user accesses pages on a server operated by a corporation. The pages include a list of jobs. Hyperlinks are associated with some of the jobs. The hyperlink refers to interview server 110, and specifies parameters that identify an interview format record. As another example, a supplied GUI provided by interview server 110 allows interviewee to initiate an asynchronous interview for a particular evaluator.

After an interview is generated, evaluators use supplied GUIs (herein referred to interview review interfaces) to retrieve the results of an asynchronous interview. The interview review interfaces allow an evaluator to select interview records, and to view and listen to an interviewees responses. The interview review interfaces also allow an evaluator to record their evaluations, and to record information about whether an interviewee merits further consideration or should be eliminated from further consideration for a particular position.

In addition, interview review interfaces allow evaluators to furnish information categories used to organize interviewees. An example of a category is job position. The interviews may then be accessed through interview review interfaces that makes interview results available through lists conveniently organized by the furnished categories. Such a mechanism allows interviews to be screened by a set of initial evaluators, and then by another set who only need review the screened interviewees. The initial evaluators associate only qualified interviewees with a particular category. Later, another set of evaluators, such as evaluators who will make to the final decision to hire an applicant for a position, access only the qualified interviewees, thereby enabling them to focus their interview review time on qualified candidates.

### Speech Rooms

After reviewing an interview record of an interviewee, it may be desirable to query the interviewee further. For example, one evaluator may wish for further details about a particular job an interviewee mentioned, while another evaluator may wish an interviewee to expand on a few courses the interviewee has completed. To facilitate further interaction and communication between interviewees and interviewers, a speech room may be established for exchanging messages.

Speech rooms are used to group exchanges of communication between a particular set of authorized users, where the exchanges of communication may include digital audio recordings of messages. Each speech room logically contains an exchange of messages and is associated with a set users who are authorized to both access messages in the speech room and to add messages to the speech room. A user may access a message, and, as a response to the message, add another message to the speech room. The other message is associated as a response to the message responded to.

According to an embodiment of the present invention, interviewers may establish speech rooms through supplied GUIs. The GUIs enable interviewers to create a speech room and establish authorized users for the speech room, which may include both interviewers and interviewees. Database 150 is used to create data that defines speech rooms, authorized users, and that tracks messages and responses to them.

A user may access speech rooms via a supplied GUI. Such a GUI would display for selection by a user the speech rooms authorized for the user. When selected, the supplied GUI displays graphical controls for each message, the graphical controls being connected in a graphical hierarchy in manner that links message to its responses.

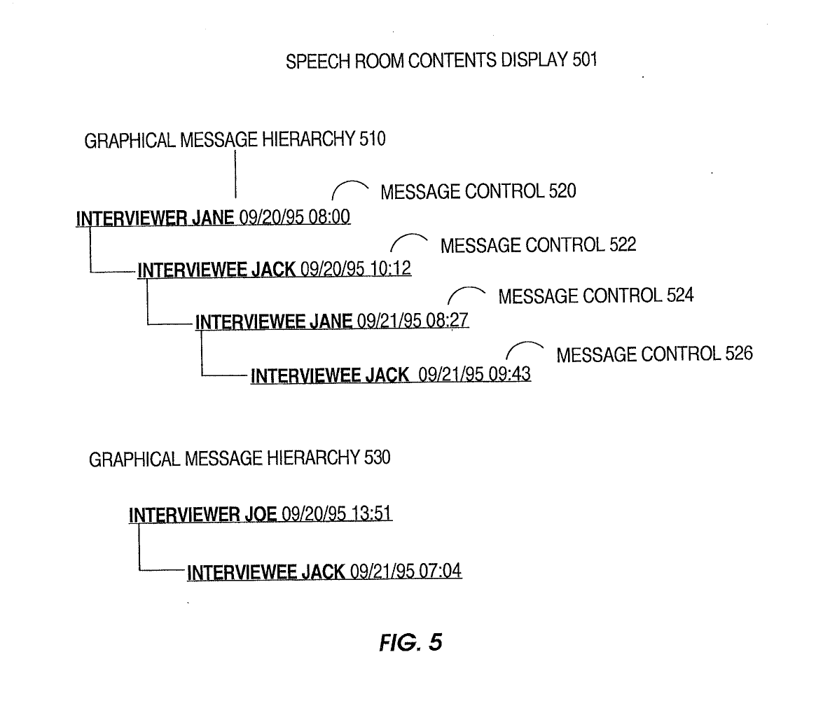

FIG. 5 is a block diagram that depicts such graphical hierarchies. Referring to FIG. 5, speech room contents display 501 is a graphical display generated in a GUI for conveying what messages are contained in a speech room. Speech room contents display 501 includes graphical message hierarchy 510 and graphical message hierarchy 530. A graphical message hierarchy displays graphical controls that each correspond to a message, and that are arranged in hierarchy that represents what messages are responses to others. Message Controls 520, 522, 524, and 526 in graphical message hierarchy 510 each displays information about a message, and in particular, the name of the person that generated the message and the time the message was completed. Message Control 522 corresponds to a response to the message represented by Message Control 520, Message Control 524 corresponds to a response to the message represented by Message Control 522, and Message Control 526 corresponds to a response to the message represented by Message Control 524.

Each of the message controls in graphical message hierarchy 510 may be clicked. When clicked, a set of graphical controls are displayed that allow a user to view the text of the message or play the digital audio recording of the message, and to reply with a response by entering a text message or recording a digital audio recording.

### Assessing Foreign Language Proficiency

The approach for conducting asynchronous interviews described herein may be used to assess foreign language proficiency. Interview formats may be designed to collect information that is used by evaluators to assess foreign language proficiency. The information collected may be text or audio responses provided in response to text or audio queries. The responses are reviewed by evaluators using interview review interfaces. The interview review interfaces collect data representing the subjective assessments of the evaluators. The assessments may rate various aspects about an interviews foreign language proficiency, including, without limitation, reading comprehension, writing skills, spoken fluency, and pronunciation quality. Conducting the interview asynchronously allows several evaluators judging the interviewee's foreign language proficiency to perform the evaluation at different locations and at different times. In fact, the evaluators may reside in different countries and time zones. There is no need to coordinate their presence with each other to conduct an interview.

In addition to collecting information about the subjective assessment of evaluators, interview formats may define multiple choice questions. Data representing answers to the multiple choice questions is collected as form data. The form data is used to generate objective scores that rate the foreign language proficiency of interviews.

It is also possible to use automatic algorithms to assess the quality of the speech and writing samples collected from the subjects.

### Evaluating the Evaluators

Human evaluators are known to be inconsistent in their judgments. They can tire or become distracted. Since key decisions may be affected by evaluators'evaluations, it is important to monitor their performance, to ascertain their consistency and how they respond to various types of interviewees. The information may be used to eliminate unreliable judges, and to form pools of evaluators that judge consistently, or, for the sake of diversity, differently. Evaluators may be monitored in various ways, as illustrated below.

The self-consistency of an evaluator may be monitored. For example, the same set of interviews may be presented to an evaluator at different times for separate evaluations. The data generated for each evaluation may be compared to determine how consistently the evaluator evaluates the same samples.

Consistency across evaluators may be monitored. For example, the same set of interviews may be presented to a pool of evaluators for evaluation. The evaluations are then compared to determine how consistently the evaluators evaluate the sample.

For purposes of illustration, an evaluation includes rating values that rate an aspect of the interviewee's foreign language proficiency. Values on a scale of 0-10 may be used to represent, for example, an evaluator's opinion about the interviewee's pronunciation skills.

To calculate consistency, reliability values may be computed using statistical correlation of the rating values generated by the evaluators. If the scores are the same, then the statistical correlation is r=1. The reliability values may be used to winnow the evaluators.

The above approach to evaluating the performance of evaluators should be considered illustrative rather than limiting. The present invention is not limited to any particular approach for evaluating evaluators using asynchronous interviews, or limited to evaluating evaluators who assess foreign language proficiency.

### Hardware Overview

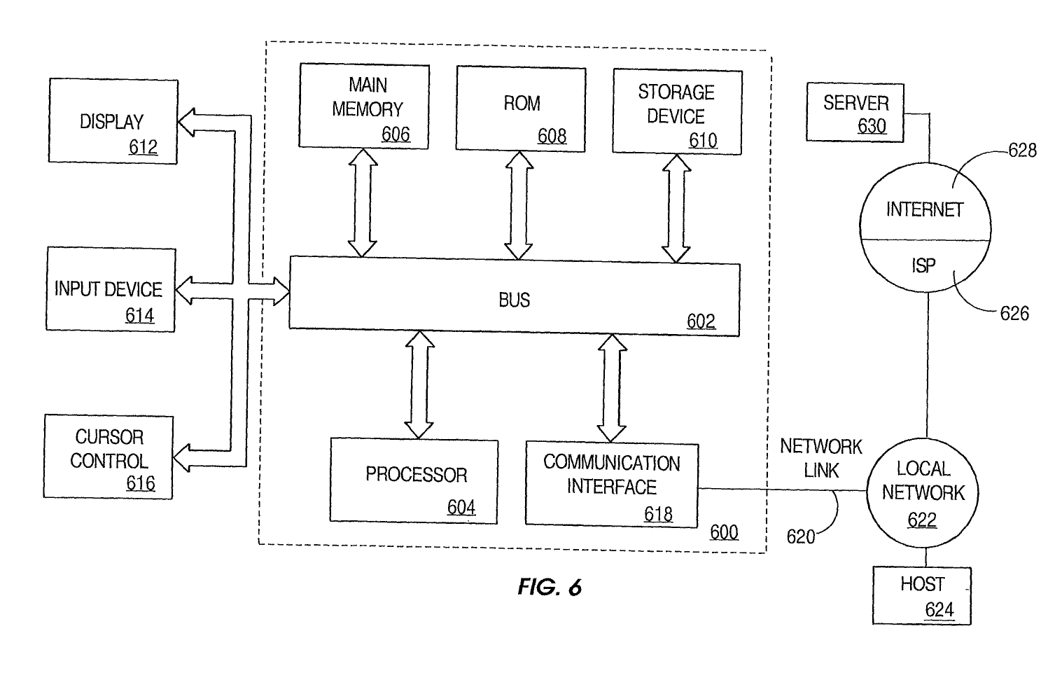

FIG. 6 is a block diagram that illustrates a computer system 600 which may be used to implement an embodiment of the invention. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for conducting interviews, the method comprising the steps of:
storing data that defines a series of promptings for an interview;
causing a client to execute said series of promptings to conduct a particular interview during which a user interface elicits at least one audio response according to said data; and
generating a digitized audio recording of said at least one audio response.

2. The method of claim 1, wherein the step of storing data that defines a series of promptings is performed by a server coupled to said client via a network.

3. The method of claim 1, wherein the step of causing a client to execute said series of promptings is performed by sending commands from a server coupled to said client via a network.

4. The method of claim 1, wherein the step of causing a client to execute said series of promptings includes the step of a server transmitting code that defines said user interface to said client.

5. The method of claim 4, wherein the step of transmitting code includes the step of transmitting code that may be executed by a browser running on said client.

6. The method of claim 1, wherein the client executes at least one prompting of said series of promptings by playing a digitized audio recording to elicit an audio response from one or more individuals interacting with said user interface.

7. The method of claim 1, wherein the client executes at least one prompting of said series of promptings by displaying text to elicit an audio response from one or more individuals interacting with said user interface.

8. The method of claim 1 further including the step of causing said digitized audio recording to be played to one or more evaluators after said particular interview is completed.

9. The method of claim 8, wherein:
the method further includes a server storing said digitized audio recording; and
the step of causing said at least one digitized audio recording to be played includes the step of said server causing another client to play said at least one audio response to one or more evaluators by performing steps that include said server transmitting said digitized audio recording to said other client.

10. The method of claim 1, further including the steps of:
receiving user input that specifies attributes about said series of promptings; and
generating said data based on said user input.

11. The method of claim 10, wherein the client executes at least one prompting of said series of promptings by playing a digitized audio recording to elicit a particular audio response from one or more individuals interacting with said user interface;
wherein said user input specifies one or more of
a maximum number of times said digitized audio recording to elicit a particular audio response may be replayed during any given interview, and
a time limit for replaying said digitized audio recording to elicit a particular audio response during any given interview.

12. The method of claim 1, wherein said data defines how said promptings may be responded to during said particular interview.

13. The method of claim 12, further including the steps of:
receiving user input that specifies attributes about said series of promptings; and generating said data based on said user input.

14. The method of claim 13, wherein said user input specifies one or more of:
a threshold number of times to rerecord another digitized audio recording of an audio response to a prompting; and
a time limit to rerecord another digitized audio recording of said audio response to a prompting.

15. The method of claim 1, wherein said particular interview elicits responses from one or more interviewees, wherein the method further includes the step of generating data that defines a speech room associated with said one or more interviewees.

16. The method of claim 1, wherein said series of promptings includes a first set of promptings that elicit information that may be used to assess foreign language proficiency.

17. The method of claim 16, wherein the method further includes:
storing data representing interview responses to said first set of promptings; and
collecting data from one or more evaluators that represent assessments by said one or more evaluators about the foreign language proficiency of an interviewee based on said interview responses.

18. The method of claim 17, wherein
said first set of promptings present multiple choice questions; and
wherein the interview responses represent answers to said multiple choice questions.

19. The method of claim 1, wherein the steps further include:
storing data representing interview responses to said series of promptings;
collecting data from one or more evaluators that represent assessments by said one or more evaluators about the interviewee based on said interview responses; and
generating information used to evaluate performance of said one or more evaluators based on said data collected.

20. The method of claim 19, wherein:
the one or more evaluators includes a first evaluator;
the step of collecting data includes collecting data representing separate evaluations by said first evaluator that assess the same characteristics about said interviewee; and
the step of generating information includes providing information used to determine how consistently said first evaluator evaluates based on said separate evaluations.

21. The method of claim 19, wherein the step of generating information includes generating information used to determine how consistent said one or more evaluators evaluate said interviewee.

22. A computer-readable medium carrying one or more sequences of instructions for conducting interviews, wherein execution of the one or more sequences of instructions by one or more processors causes the one or more processors to perform the steps of:
storing data that defines a series of promptings for an interview;
causing a client to execute said series of promptings to conduct a particular interview during which a user interface elicits at least one audio response according to said data; and
generating a digitized audio recording of said at least one audio response.

23. The computer-readable media of claim 22, wherein the step of storing data that defines a series of promptings is performed by a server coupled to said client via a network.

24. The computer-readable media of claim 22, wherein the step of causing a client to execute said series of promptings is performed by sending commands from a server coupled to said client via a network.

25. The computer-readable media of claim 22, wherein the step of causing a client to execute said series of promptings includes the step of a server transmitting code that defines said user interface to said client.

26. The computer-readable media of claim 25, wherein the step of transmitting code includes the step of transmitting code that may be executed by a browser running on said client.

27. The computer-readable media of claim 22, wherein the client executes at least one prompting of said series of promptings by playing a digitized audio recording to elicit an audio response from one or more individuals interacting with said user interface.

28. The computer-readable media of claim 22, wherein the client executes at least one prompting of said series of promptings by displaying text to elicit an audio response from one or more individuals interacting with said user interface.

29. The computer-readable media of claim 22 further including instructions for performing the step of causing said digitized audio recording to be played to one or more evaluators after said particular interview is completed.

30. The computer-readable media of claim 29, wherein:
the computer-readable media further includes instructions for a server to store said digitized audio recording; and
the step of causing said at least one digitized audio recording to be played includes the step of said server causing another client to play said at least one audio response to one or more evaluators by performing steps that include said server transmitting said digitized audio recording to said other client.

31. The computer-readable media of claim 22, further including instructions for performing the steps of:
receiving user input that specifies attributes about said series of promptings; and
generating said data based on said user input.

32. The computer-readable media of claim 31, wherein the client executes at least one prompting of said series of promptings by playing a digitized audio recording to elicit a particular audio response from one or more individuals interacting with said user interface;
wherein said user input specifies one or more of
a maximum number of times said digitized audio recording to elicit a particular audio response may be replayed during any given interview, and
a time limit for replaying said digitized audio recording to elicit a particular audio response during any given interview.

33. The computer-readable media of claim 22, wherein said data defines how said promptings may be responded to during said particular interview.

34. The computer-readable media of claim 33, further including instructions for performing the steps of:
receiving user input that specifies attributes about said series of promptings; and generating said data based on said user input.

35. The computer-readable media of claim 34, wherein said user input specifies one or more of:
a threshold number of times to rerecord another digitized audio recording of an audio response to a prompting; and
a time limit to rerecord another digitized audio recording of said audio response to a prompting.

36. The computer-readable media of claim 22, wherein said particular interview elicits responses from one or more interviewees, wherein the computer-readable media further includes instruction for performing the step of generating data that defines a speech room associated with said one or more interviewees.

37. The computer-readable media of claim 22, wherein said series of promptings includes a first set of promptings that elicit information that may be used to assess foreign language proficiency.

38. The computer-readable media of claim 37, wherein the steps further include:
storing data representing interview responses to said first set of promptings; and
collecting data from one or more evaluators that represent assessments by said one or more evaluators about the foreign language proficiency of an interviewee.

39. The computer-readable media of claim 38, wherein
said first set of promptings present multiple choice questions; and
wherein the interview responses represent answers to said multiple choice questions.

40. The computer-readable media of claim 22, the steps further include:
storing data representing interview responses to said series of promptings;
collecting data from one or more evaluators that represent assessments by said one or more evaluators about the interviewee based on said interview responses; and
generating information used to evaluate performance of said one or more evaluators based on said data collected.

41. The computer-readable media of claim 40, wherein:
the one or more evaluators includes a first evaluator;
the step of collecting data includes collecting data representing separate evaluations by said first evaluator that assess the same characteristics about said interviewee; and
the step of generating information includes providing information used to determine how consistently said first evaluator evaluates based on said separate evaluations

42. The computer-readable media of claim 40, wherein the step of generating information includes generating information used to determine how consistent said one or more evaluators evaluate said interviewee.
